(19) United States
(12) Patent Application Publication
(10) Pub. No.: US 2004/0179249 A1
(43) Pub. Date: Sep. 16, 2004

(54) Simplified image sensor module

(76) Inventors: Jackson Hsieh, Hsinchu Hsien (TW); Jichen Wu, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/386,068

(22) Filed: Mar. 10, 2003

(51) Int. Cl. H04N 1/04; H04N 1/46

(52) U.S. Cl. 358/505; 358/474

(57) ABSTRACT

A simplified image sensor module includes a substrate, a frame layer, a photosensitive chip, a plurality of wires, and transparent glue. The substrate has an upper surface and a lower surface. The frame layer is arranged on the upper surface of the substrate to form a cavity together with the substrate. The photosensitive chip is mounted to the upper surface of the substrate and is located within the cavity. The wires electrically connect bonding pads of the photosensitive chip to the substrate. The transparent glue is filled in the cavity to encapsulate the photosensitive chip and is formed with a convex portion corresponding to the photosensitive chip. Therefore, the photosensitive chip may receive focused optical signals focused by the convex portion of the transparent glue.

### BACKGROUND OF THE INVENTION

1. Field of the Invention

The invention relates to a simplified image sensor module, and in particular to an image sensor module having a simplified structure that may be manufactured easily. and in low cost.

2. Description of the Related Art

Referring to FIG. 1, a conventional image sensor module includes a lens holder 10, a lens barrel 20, and an image sensor 30. The lens holder 10 has a top face 12, a bottom face 14 and a chamber 16 penetrating through the lens holder 10 from the top face 12 to the bottom face 14. The chamber 16 of the lens holder 10 is formed with an internal thread 18. The lens barrel 20 is formed with an external thread 22, inserted into the chamber 16 from the top face 12 of the lens holder 10, and screwed to the internal thread 18 of the lens holder 10. The lens barrel 20 is also formed with a transparent region 24. An aspheric lens 26 is arranged within the chamber 16 and under the transparent region 24. An infrared filter 28 is also arranged within the chamber and under the aspheric lens 26. The image sensor 30 has a first face 32 and a second face 34. The first face 32 is provided with a transparent layer 36. The transparent layer 36 of the image sensor 30 is adhered to the bottom face 14 of the lens holder 10. The focal length between the aspheric lens 26 of the lens barrel 20 and the transparent layer 36 of the image sensor 30 may be controlled by adjusting the screwed length between the lens barrel 20 and the lens holder 10.

However, the above-mentioned image sensor module has the following drawbacks.

1. The manufacturing processes are complicated because the image sensor 30 has to be packaged and then combined with the lens holder 10 and the lens barrel 20 to form a module so that the image sensor 30 may receive optical signals focused by the aspheric lens 26. Therefore, the structure of the image sensor module is complicated and the overall volume thereof is large.

2. Since the transparent layer 36 is adhered to the bottom face 14 of the lens holder 10 by an adhesive, the adhesive may contaminate the surface of the transparent layer 36 and the image sensor cannot receive the optical signals normally.

3. When the module is assembled, the transparent layer 36 has to be precisely aligned with the aspheric lens 26 and then adhered to the aspheric lens 26. After the adhering process, if the transparent layer 36 and the aspheric lens 26 are not aligned properly, the overall module cannot be disassembled and reassembled, and the module has to be treated as a waste material.

### SUMMARY OF THE INVENTION

An object of the invention is to provide a simplified image sensor module having a simplified structure that may be manufactured easily and in low cost.

Another object of the invention is to provide a simplified image sensor module having a miniaturized volume.

To achieve the above-mentioned objects, the invention provides a simplified image sensor module including a substrate, a frame layer, a photosensitive chip, a plurality of wires, and transparent glue. The substrate has an upper surface and a lower surface. The frame layer is arranged on the upper surface of the substrate to form a cavity together with the substrate. The photosensitive chip is mounted to the upper surface of the substrate and is located within the cavity. The wires electrically connect bonding pads of the photosensitive chip to the substrate. The transparent glue is filled in the cavity to encapsulate the photosensitive chip and is formed with a convex portion corresponding to the photosensitive chip.

Therefore, the photosensitive chip may receive focused optical signals focused by the convex portion of the transparent glue.

### BRIEF DESCRIPTION OF THE DRAWINGS

FIG. 1 is a cross-sectional view showing a conventional image sensor module.

FIG. 2 is a first schematic illustration showing a simplified image sensor module of the invention.

FIG. 3 is a second schematic illustration showing the simplified image sensor module of the invention.

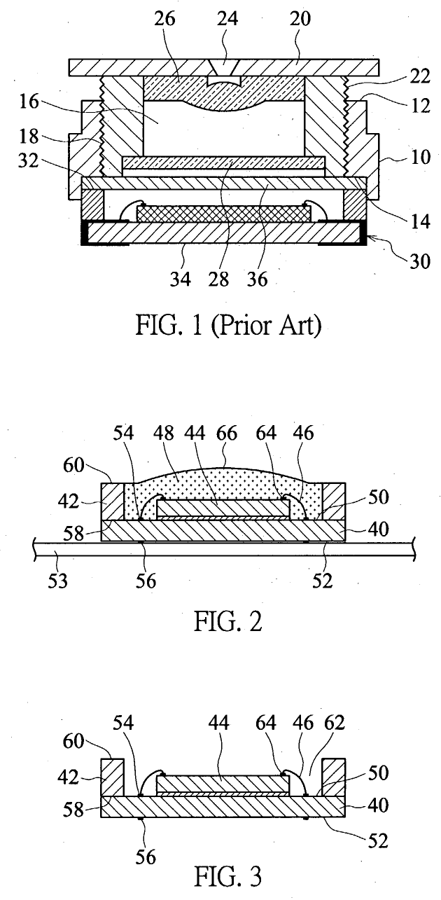

### DETAILED DESCRIPTION OF THE INVENTION

Referring to FIGS. 2 and 3, an image sensor module of the invention includes a substrate 40, a frame layer 42, a photosensitive chip 44, a plurality of wires 46 and transparent glue 48.

The substrate 40 has an upper surface 50 on which a plurality of first connection points 54 is formed, and a lower surface 52 on which a plurality of second connection points 56 for being electrically connected to a printed circuit board 53 is formed.

The frame layer 42 has a first surface 58 and a second surface 60, wherein the first surface 58 is arranged on the upper surface 50 of the substrate 40. The frame layer 42 and the substrate 40 form a cavity 62.

The photosensitive chip 44 is formed with a plurality of bonding pads 64 and is mounted to the upper surface 50 of the substrate 40 and located within the cavity 62.

The wires 46 electrically connect the bonding pads 64 of the photosensitive chip 44 to the first connection points 54 of the substrate 40 so as to transfer signals from the photosensitive chip 44 to the substrate 40.

The transparent glue 48 is filled in the cavity 62 to encapsulate the photosensitive chip 44 and is formed with a convex portion 66 corresponding to the photosensitive chip 44. The convex portion 66 may be an arc-shape structure and may focus optical signals to the photosensitive chip 44.

After the photosensitive chip 44 is packaged, it can receive focused optical signals by the provision of the convex portion 66 of the transparent glue 48. Therefore, the image sensor of the invention does not need to use another lens module, the product size can be effectively reduced, the manufacturing processes may be simplified, and the manufacturing cost may be effectively lowered.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A simplified image sensor module, comprising:
a substrate having an upper surface and a lower surface;
a frame layer having a first surface and a second surface, the first surface being arranged on the upper surface of the substrate, and the frame layer and the substrate forming a cavity;
a photosensitive chip formed with a plurality of bonding pads, the photosensitive chip being mounted to the upper surface of the substrate and located within the cavity;
a plurality of wires for electrically connecting the bonding pads of the photosensitive chip to the substrate; and
transparent glue filled in the cavity to encapsulate the photosensitive chip and formed with a convex portion corresponding to the photosensitive chip.

2. The image sensor module according to claim 1, wherein the upper surface of the substrate is formed with a plurality of first connection points, and the wires electrically connect the bonding pads of the photosensitive chip to the first connection points, respectively.

3. The image sensor module according to claim 1, wherein the lower surface of the substrate is formed with a plurality of second connection points.

4. The image sensor module according to claim 1, wherein the convex portion has an arc-shaped structure.
